(19) United States
(12) Patent Application Publication
(10) Pub. No.: US 2016/0082557 A1
(43) Pub. Date: Mar. 24, 2016

(54) ROBOTIC APPARATUS AND PROCESS FOR THE INSTALLATION OF COLLARS AND NUTS ONTO FASTENERS

(71) Applicant: KUKA Systems Corporation North America, Sterling Heights, MI (US)

(72) Inventors: Daniel C. Friz, Washington, MI (US); Jeffrey W. Camphous, Harrison Township, MI (US); Randy P. Woolridge, St. Clair Shores, MI (US); James B. Cole, Clinton Township, MI (US); Timothy G. Corbett, St. Clair Shores, MI (US); Patrick Jesse Griffin, Royal Oak, MI (US)

(21) Appl. No.: 14/860,915

(22) Filed: Sep. 22, 2015

Related U.S. Application Data
(60) Provisional application No. 62/053,426, filed on Sep. 22, 2014.

(51) Int. Cl. B23P 19/06; F16B 31/02; B25J 9/16; B25B 23/00

(52) U.S. Cl. CPC B23P 19/06; B25B 23/0085; F16B 31/021; B25J 9/1687; Y10S 901/41

(57) ABSTRACT

Apparatus and process for the installation of collars and/or nuts on fasteners, particularly in the aerospace industry. The apparatus includes an industrial base robot supporting a mounting base carrying a gimbal and rotary drive for a lightweight sensing robot with a fastening/torque tool. The sensing robot operates to align and position a spin preventing projection such as a hex key in a fastener end and a rotatable socket to torque a nut or collar onto the fastener held against rotation. The related process is accomplished by sensors in conjunction with the sensing robot aligning the hex key with a recess in the fastener end, inserting the key into the fastener to hold it against rotation, and spinning a nut or collar onto the fastener. A wrenching component is sheared from the nut and removed after the nut or torque is applied.

### PRIORITY CLAIM

Benefit is claimed of the filing date of Sep. 22, 2014 of U.S. Provisional Patent Application Ser. No. 62/053,426, which application is herewith incorporated herein by reference.

### FIELD OF THE INVENTION

This invention relates to the automatic alignment and torquing of backside nuts or collars onto fasteners such as bolt pins used in automated industrial assembly processes such as in the aerospace industry, and more particularly in one-up assembly processes.

### BACKGROUND OF THE INVENTION

The aerospace industry has been addressing the need to introduce automated techniques for drilling of work pieces and fastener insertion and torquing therein for the past decade. The latest trend is to attempt to implement flexible automation, via industrial robots, to limit the required floor space required for the process. However, the next evolution of drilling and fastener insertion automation requires alignment and installation of a backside collar or nut on a threaded fastener such as a bolt or pin at a specified torque.

The installation of collars or nuts to such fasteners has predominately been a manual task within the aerospace industry, due to the complexity and obstacles inherently presented by current automation capacities. The primary obstacle has been the difficulty in aligning and applying the parts in emulation of human motion of alignment and torquing. Key variables of spinning a collar or nut onto a threaded fastener include the proper alignment of the collar or nut to the fastener, mitigating cross threading, and the holding of the fastener against turning or spinning as the nut or collar is spun thereon and torqued to a specific parameter.

Another variable that is challenging is that of the smaller size fasteners to which a nut or collar must be aligned, and the holding of the fastener against spinning, when extended into and through a part drill hole of non-interference in relation to the fastener (in other words a hole whose diameter is greater than the outside diameter of the fastener to such extent the fastener can rotate in the hole). The variety of aerospace fasteners and the mechanical difficulty of aligning and engaging the fasteners make the indexing of the nut or collar on the fastener and the rotation of the nut or collar to full engagement to complete the threaded torque down operation, without rotating the fastener, very difficult. Thus it is desired to fully automate the alignment and torque of a nut onto a fastener in a manner duplicating the haptic or sensory capacities of a human.

### SUMMARY OF THE INVENTION

To these ends, these variables and obstacles are addressed by the combination of an industrialized sensing or second robot as an end effector in conjunction with a more traditional base or first robot supporting and operating the sensing robot, applied to align and torque nuts onto fasteners in an industrial operation as if conducted by human capacity.

A unique robot-on-robot collaboration according to the invention assists in the starting point angle of the collar alignment process and the part fastening operation. This collaboration also makes possible the use of a base robot to place a pressure-foot firmly square to the part stack-up for the pin insertion.

The use of an industrialized sensing robot with compliant axes (e.g., such as shown in Design Patent No. D692,041 incorporated herein by reference) and available commercially from KUKA Robotics Corporation of Shelby Township, Michigan as robot model KUKA LBR iiwa, and in U.S. Pat. No. 8,594,847 incorporated herein by reference, renders viable human-to-robot emulation through its sensory technology. However, this sensory technology is here utilized and particularly adapted, according to the invention, to mimic human functionality in a way previous industrial robots or systems do not. The torque sensors in each axis of the sensing robot allow the robot to align a spin-preventing component and socket drive with the fastener thus allowing it to ensure, for example, proper thread engagement (without cross-threading) of the collar or nut to a bolt pin and without a cooperating or ancillary vision system. This ability through the compliant axes of the sensing robot is also useful for the engagement of a fastening/torque tool carrying a fastener socket driver and spin preventing mechanism, described below, and for torquing a nut or collar onto the fastener. According to the invention, fasteners such as threaded bolt pins are modified to include a shape specific internal bore or recess for engagement by a projecting component of the fastening torque tool carried by the sensing robot. This inserted, projecting component keeps the fastener from spinning during nut or collar rotation and torquing. Torque sensors associated with the sensing robot and with the fastening/torque tool sense torque from the nut collar threading onto the fastener and provide data aberrations from cross threading or product structure. Sensed torque can provide data for control, start-over, rejection or other parameters as programmed in any suitable control in the particular application. Thus the invention provides process and application for , without a vision system, automatically aligning and securing a nut or collar to a bolt pin which in turn secures work pieces together. In addition, it will be appreciated that the fastening/torque tool also electronically provides reliable torque data useful with torque data from the sensing robot in the nut torquing.

Thus the invention provides haptic or compliance feedback operation in the application of applying and torquing nuts onto fasteners in industrial applications.

### BRIEF DESCRIPTION OF THE DRAWINGS

These and other objectives, advantages, apparatus and processes will become readily apparent from the following detail and written description and from the drawings appended hereto as follows:

FIG. 1 is an isometric illustration of the invention including a base industrial robot, a lightweight sensing robot, a mounting base carried by the base industrial robot, a clamp foot carried by the mounting base and a fastening/torque tool carried and operated by the lightweight sensing robot.

FIG. 2 is an isometric view of the invention of FIG. 1 from the other side further showing rotary and gimbal drives and mounts for the lightweight sensing robot;

FIG. 3 is an illustrative cross-sectional sketch of the fastener and approaching nut or collar and fastener holding/nut driver of the invention;

FIG. 4 is similar to FIG. 3 but illustrates a fastener with a nut or collar in aligned position for rotating onto the threaded fastener;

FIG. 5 is an elevational, illustrative view in partial cross-section of a fastener; and

FIG. 6 is an elevational, illustrative view as in FIG. 5 but showing in addition a nut or collar threaded onto the fastener with a collar wrenching apparatus sheared off from the nut or collar during assembly.

### DETAILED DESCRIPTION OF THE INVENTION

As used herein, the term , “fastener”, refers to and includes any suitable fastener, preferably threaded at or proximate one end, and including bolts, bolt pins, screws or the like, which may be used interchangeably for such fasteners.

The term, “sensing robot”, as used herein generally refers to handling robots, such as industrial robots according to the existing art, having a manipulator normally having two to six motion axes, which are normally rotational motion axes. The motion axes of the manipulator can each have force or torque sensors and/or position sensors assigned to them, with which the position and the forces or torques of the particular motion axes are registered directly. The motion axes are normally joints of a multisectional manipulator arm, or a pivot joint between the manipulator arm and the robot base. An end effector, for example a gripper, is normally situated at the free end of the manipulator or manipulator arm. Besides the pure control or regulation of position with the aid of the position sensors assigned to the motion axes, force and/or moment sensors of the motion axes may be utilized to monitor or control the forces and torques occurring at the manipulator arm.

The monitoring, controlling and regulating of torques and forces that act on the manipulator is a necessary, or at least a desired type of regulation in many applications. For example, the manipulator can be controlled or regulated by means of force and moment axis sensors of the manipulator to generate a particular force or torque on a component. With moving attachments and/or basic components, it is possible to use force and/or moment axis sensors on the manipulator to prevent canting. The force and moment sensors of the manipulator can also be used to detect collisions.

In industrial applications, the industrial robot is normally operated in an automatic mode. The industrial robot uses its manipulator to repeatedly carry out preprogrammed movement patterns independently. Since there is no direct human control in automatic mode, reliable functioning of all control and regulatory circuits is imperative to avoid misinterpreting the position and motion of the manipulator, as described in U.S. Pat. No. 8,594,847 which is fully incorporated herein by reference and is filed herewith as a part hereof.

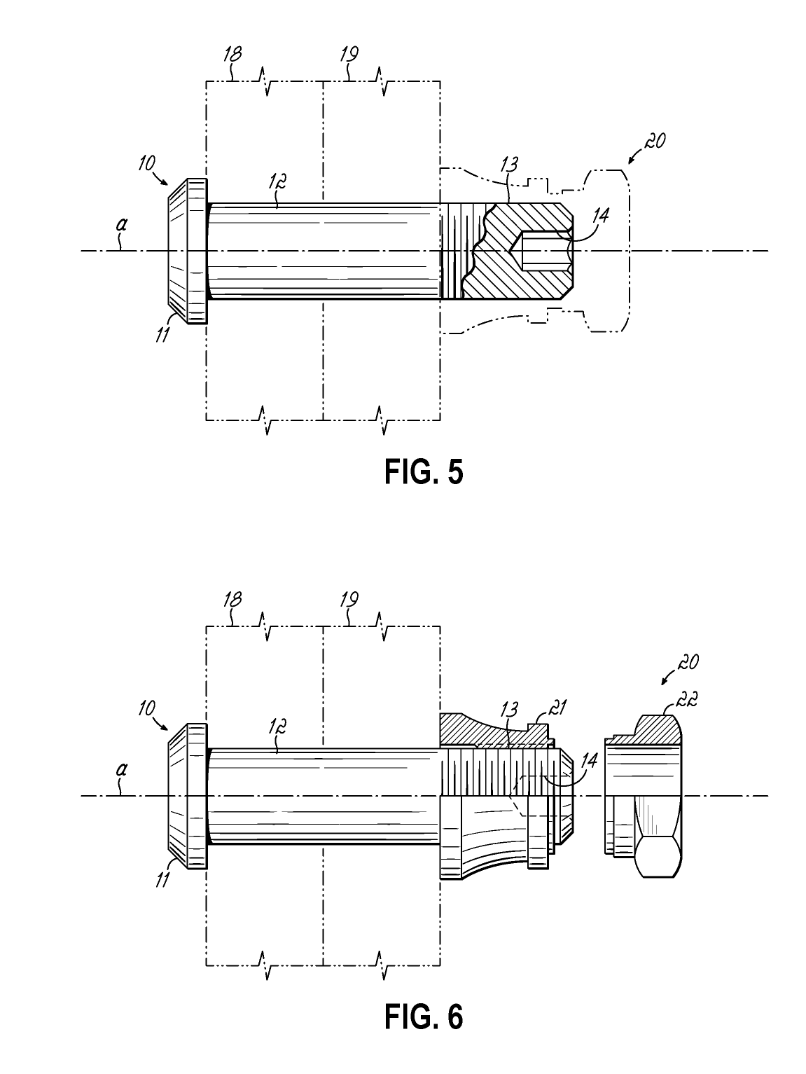

Turning now to the Figures, and particularly to FIGS. 5 and 6 initially, there is disclosed therein a fastener or pin bolt 10 on an axis “a” having a head 11, an extended shank 12 and a threaded portion 13 at or proximate a distal end portion of shank 12 from head 11. The pin bolt 10 may also be referred to as a pin, bolt, screw or fastener as shown. Threaded portion 13 of shank 12 is shown in partially cut-away fashion in FIG. 5 and thus facilitates illustration of a square sided, hexagonally-shaped or multi-sided recess or bore 14 provided co-axially in the end of bolt 10 opposite head 11.

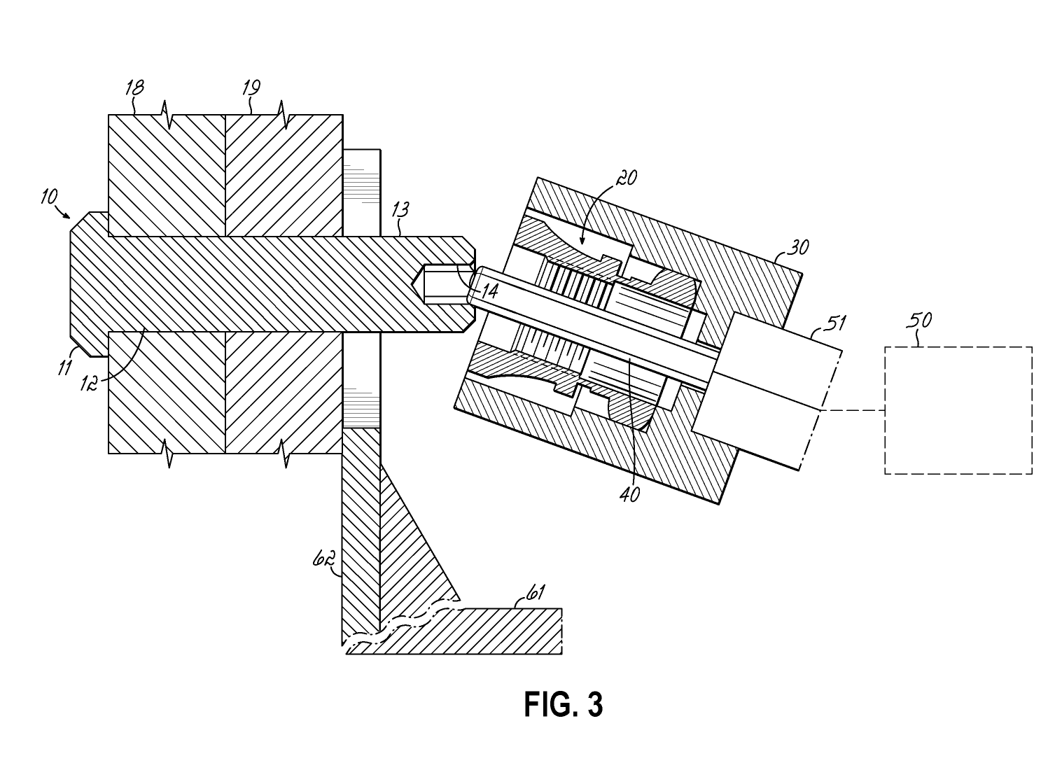

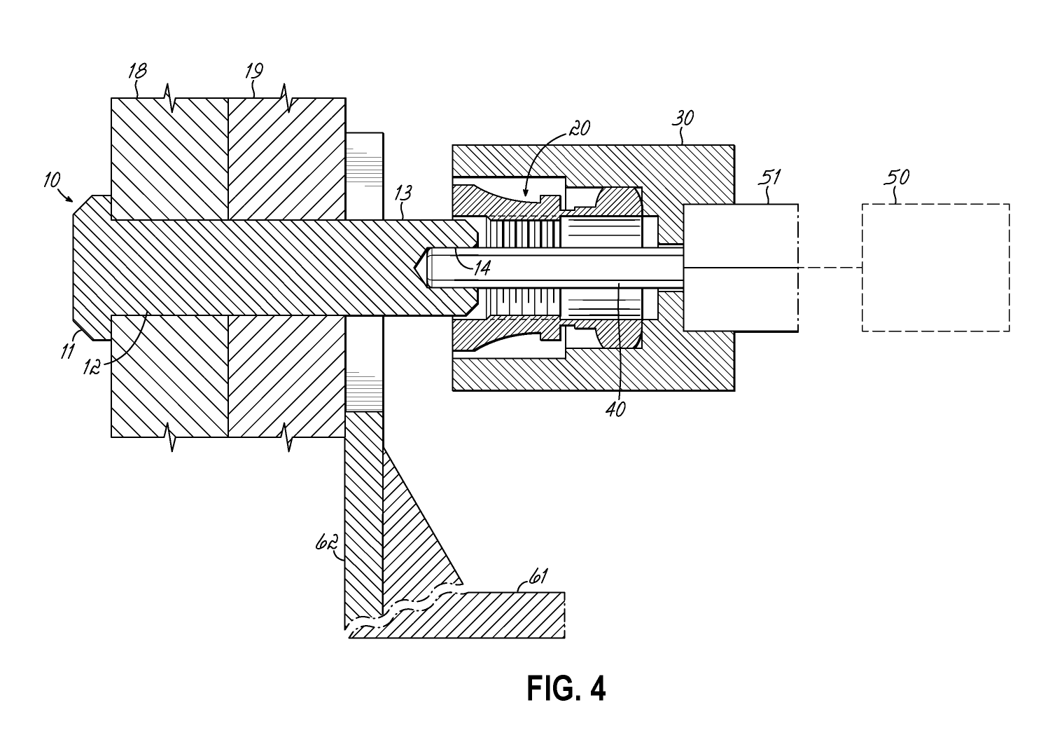

For illustration, pin bolt 10 is shown extending through two work piece parts 18, 19 (see FIGS. 3, 4). Parts 18, 19 are shown for environment purposes only in dashed lines in FIGS. 5, 6, and it is these parts that pin bolt 10 serves to hold together.

With continued reference to FIG. 6, a nut or collar 20 is shown comprising preferably two components 21, 22. Component 21 comprises a permanent nut or collar member for operative threading onto threaded portion 13 of bolt 10. Component 22 comprises a wrenching element initially but frangibly secured to component 21. Upon application of a predetermined torque to nut or collar 20, as described herein, and after proper torquing of nut or collar 20, the nut or collar 20 stops and component 22 shears off from the permanent element 21, leaving element 21 in place on bolt 10, securing pieces 18, 19 between head 11 and component 21. Element 22 is then removed.

Nut or collar 20 is made of any suitable material or materials for suitable engagement with bolt 10.

FIG. 5 illustrates bolt 10 with the nut 20 in dashed lines for clarity on illustration of bolt 10, while FIG. 6 illustrates final placement of nut or collar component 21 on bolt 10, with a portion of the components of nut 20 shown in partial cross section.

With reference now to FIGS. 3 and 4, these FIGS. illustrate the process of collar alignment with bolt 10 (FIG. 3) and final positioning of collar 20 on bolt 10, FIG. 4.

FIGS. 3 and 4 further illustrate both the collar spinning socket wrench 30 and the bolt locating and anti-rotating projecting hex pin 40.

As noted previously, bolt 10 has or defines a multi-sided, preferably square-sided or box-shaped bore 14 therein. More preferably bore 14 is in the shape of hexagonal configuration, generally about axis a.

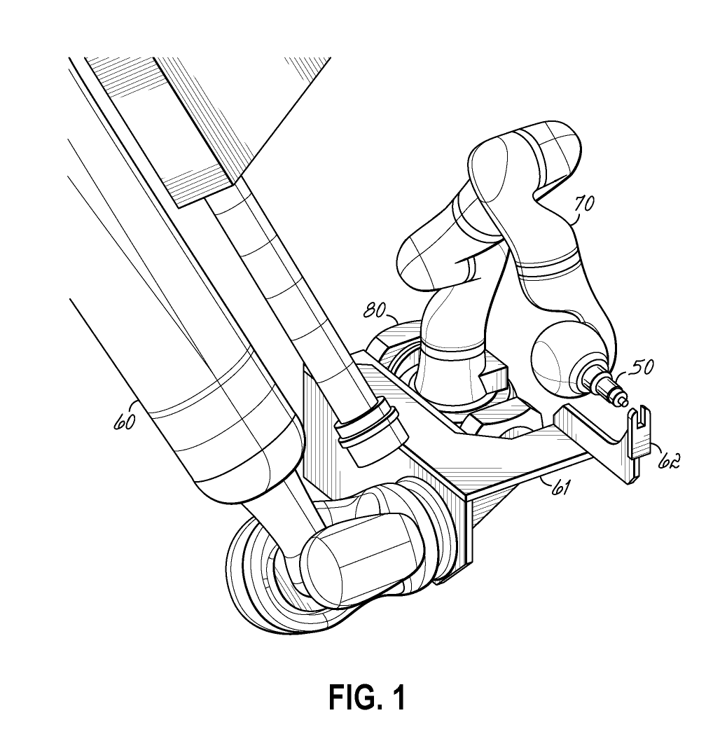

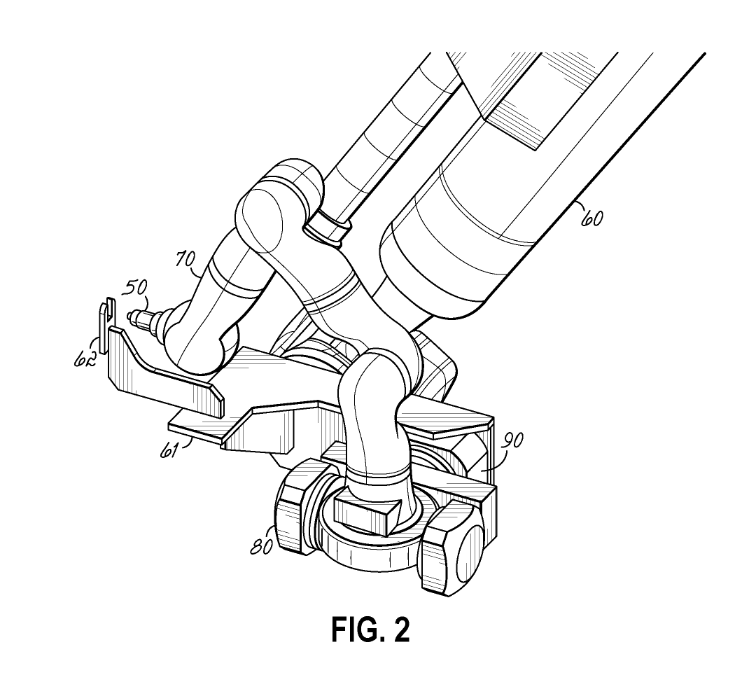

A hex-shaped pin 40 extends forwardly toward bolt 10 from the fastening/torque tool 50 (the fastening torque tool of FIGS. 1, 2). The torque tool 50 drives a square, socket rotating driver 51, or other shaped driver for socket wrench 30 as only graphically illustrated in FIGS. 3, 4. At the same time, hex pin 40 is fastened to apparatus 50 in a non-rotational function so hex pin 40 (FIG. 4) does not spin or turn with respect to socket 30. When hex pin 40 is in bore 14, bolt pin 10 is prevented from rotation, regardless of the parameters of bolt-receiving apertures in parts 18, 19 in any suitable manner.

Fastening torque tools such torque tool 50 are of any suitable construction, available as off-the-shelf items. Fastener torque tool 50 also includes torque sensors, as will be appreciated, which provide reliable torque data used with that provided by robot 70 to monitor different portions of the process.

FIG. 3 illustrates the approach of pin 40, nut 20 and socket 30 toward bolt 10, but at an arbitrary angle thereto, (FIG. 3) such as likely to be encountered in an assembly process. End of pin 40 seeks and is introduced into the bore 14 of bolt 10 thereafter holding it against rotation as socket 30 and collar 20 approach the bolt 10, and align collar or nut 20 with the threads 13 of bolt 10. Positioning and introduction of hex key 40 onto recess 14 is facilitated by the sensors associated in the axes of the sensing robot. Socket 30 is then spun to thread nut 20 onto pin 10, but pin 10 is held against rotation by non-rotating hex pin 40 in bore 14, even if bolt 10 is in non-binding or non-interfering relation with pieces 18, 19 (see FIG. 4). Any cross-threading of element 20 on bolt 10 is sensed by the torque sensors of the sensing robot 70, also indicating a degree of torque indicative of a product structure out of tolerance or aberration. Data from such torque sensing is used for reporting, control, start over or any other responsive protocol dictated by any suitable the application programming as will be appreciated.

Socket 30 engages shear element 22 to drive nut 21 element onto bolt 10. Once element 21 is set on threads 13 to proper torque against piece 19, driven or driver element 22 thereafter shears off from element 21, leaving nut or collar 22 (20) securely in place on bolt 10 against piece 19.

Socket 30, with element 22 and pin 40 is withdrawn axially, leaving bolt 20 and torqued element 21 holding pieces 18, 19 together.

Turning now to FIGS. 1 and 2, there is shown therein the robotic combination supporting and orienting the nut aligning and torquing elements as described above.

In FIG. 1, the invention is illustrated and includes an industrial robot 60, a lightweight sensing robot 70 carried by a mounting base or plate 61 and the industrial base robot 60. Base robot 60 is any suitable robot such as robot model KR210 available from KUKA Robotics Corporation of Shelby Township, Mich. One form of sensing robot 70 is described above.

A clamp foot 62 is secured to base plate 61, and in operation engages a work piece 19 (see for example FIG. 3) to support workpieces 18, 19 when pin bolt 10 is seated therein.

A fastening torque tool 50 (including socket 30 and hex pin 40) is carried by the lightweight sensing robot 70 for aligning and spinning the nut 20 onto pin bolt 10 as illustrated in FIGS. 3 and 4.

Turning to FIG. 2 the sensing robot 70 is carried by a gimbal mount 80 and is supported on a rotary drive 90 for movement in multiple axes to facilitate alignment of nut 20 with bolt 10 (FIGS. 3 and 4).

Clamp foot 62 is biased by robot 60 against workpieces 18, 19 and any suitable sensors associated with robot 70 serve to align fastening torque tool 50 and nut 20 with bolt 10 to spin and secure nut part 21 on bolt 10 without cross-threading.

It will be appreciated that any suitable sensing robot such as robot 70, described above, together with associated sensors, and operating in conjunction with base robot 60 such as described above, for initial gross-point positioning can be used as described herein to accurately position nut 20 with respect to bolt 10 and to align spin preventing pin 40 with bolt 10, thereafter allowing tool 50 to complete nut-to-bolt threading and then retreat.

Thus even where a nut 20 is not initially aligned with a fastener 10, the combination of robots 60, and 70, with tool 50, is useful to automate the alignment and assembly of nut-to-fastener, without human intervention, but with the same or similar result.

With more particularity, the sensing or robot 70 according to this invention is available as described above and is further described in detail in the following patents and patent applications incorporated herein by reference and including U.S. Design Patent No. D692,041, U.S. Pat. No. 8,649,906 published under No. U.S. 2010/0324733; German patent documents DE 10 2007 063 099 A1; DE 10 2007 014 023 A1; and DE 10 2007 028 758 B4; as well as EP 1972414 (B1) and EP 2006 055 (B1), all incorporated herein by reference and copies of which are filed herewith as part hereof.

Positional sensing and location of hex pin 40 in recess 14 is provided by such robot 70 as well as threading and turning of nut or collar 20 onto fastener 10, rendered operational by robot 70 according to the capabilities of such robot as described here and in the US and foreign patent documents incorporated herein by reference. It will be appreciated that any suitable controls and software consistent with this disclosure can be used with these components.

Thus according to the invention, the sensing or second robot 70 is located proximate the work parts and fastener 10 by the base or first robot 60, then positions the hex key or pin 40 in alignment with the recess 14 in the fastener 10 to hold it against spinning as the nut 20 is torqued down by socket 30, controlled or monitored by torque sensors of the sensing robot.

Any suitable control system for the robots can be used to produce the operations as described herein.

These and other modifications and advantages will be appreciated from the foregoing description and drawings without departing from the scope of the invention and applicant intends to be limited only by the claimed appended hereto.

What is claimed is:

1. Automated robotic apparatus for aligning and assembling together fastener and nut components and including:
a first robot;
a second robot;
said second robot carried and manipulated by said first robot;
a fastening torque tool carried by said second robot and including a nut driving socket and a fastener spin preventing element;
said tool adapted for carrying a nut for aligning with, then threading onto said fastener, after said aligning;
said fastener spin preventing element engageable with said fastener to prevent it from spinning when a nut is threaded thereon.

2. Apparatus as in claim 1 wherein said second robot is a sensing robot.

3. Apparatus as in claim 2 wherein said first robot includes a mounting plate and said second robot is mounted on said mounting plate.

4. Apparatus as in claim 3 further including a clamping foot on said mounting plate for engaging against a workpiece.

5. Apparatus as in claim 3 including a rotary drive and gimbal mount mounted on said mounting plate and operably connected to said second robot.

6. Apparatus as in claim 1 wherein said socket is configured to receive a two-part nut having a threaded portion for threading onto a fastener and a second portion for driving engagement by said socket.

7. Apparatus as in claim 6 wherein said second portion is shearable from said threaded portion when said threaded portion is turned onto a fastener.

8. Apparatus as in claim 1 for use with a fastener having a head, a shank and a threaded portion, said fastener having an internal bore for receiving a pin having complimentary exterior surface for engaging said fastener bore and preventing said fastener from turning.

9. Apparatus as in claim 8 wherein said nut is moveable in an axial direction with respect to said pin having said complimentary exterior surface when said nut is threaded onto said fastener.

10. A two-part nut for threading onto a fastener in an automated assembly process wherein a first part of said nut is threadable for engagement with said fastener, and wherein a second part of said nut is shearable from said first part.

11. A nut as in claim 10 wherein said second part thereof is positively engageable with a driving socket for turning and wherein said first part is rotatable with respect to said driving socket.

12. In combination, a threaded fastener, and a nut threadable thereon, and a spin preventing
element engageable with said fastener,
said fastener having a bore therein,
said bore having internal surfaces,
said spin preventing element comprising a projection insertable into said bore and preventing fastener rotation when in said bore.

13. A process for assembling a nut to a fastener extending through a workpiece including the steps of:
aligning a spin-preventing element with said fastener with a sensing robot;
advancing both said nut and spin retaining element toward said fastener;
engaging a spin retaining element with said fastener to prevent fastener spinning;
threading said nut onto said fastener; and
torquing said nut against a workpiece;

14. A process as in claim 13 further including:
shearing off a portion of said nut; and
withdrawing said sheared off portion and said spin retaining element from said fastener.

15. A process as in claim 13 including sensing torque of turning said nut onto said fastener.
